(19) United States
(12) Patent Application Publication
(10) Pub. No.: US 2010/0056049 A1
(43) Pub. Date: Mar. 4, 2010

(54) Wireless Mobile Telescanners

(76) Inventor: Darwin Hu, San Jose, CA (US)

Correspondence Address: SILICON VALLEY PATENT AGENCY, 7394 WILDFLOWER WAY, CUPERTINO, CA, 95014, US

(21) Appl. No.: 12/204,268

(22) Filed: Sep. 4, 2008

(51) Int. Cl. H04B 7/00; H04N 1/04

(52) U.S. Cl. 455/41.2; 358/474

(57) ABSTRACT

A mobile scanner with telecommunication functions is disclosed. The mobile scanner is designed to be able to wirelessly transport scanning data to a computing device (e.g., a fax machine or an email server). Unlike a USB-based mobile scanner, the scanner operates without being connected to a computing device. With an embedded wireless module, the scanning data can be transported via a standard wireless protocol (e.g., WiFi, WiMAX, or Bluetooth), or a standard cellular standard (e.g., GSM or CDMA).

### BACKGROUND OF THE INVENTION

1. Field of the Invention

The present invention generally relates to a portable scanning device and more particularly relates to a mobile scanner that utilizes existing wireless or cellular infrastructures to transport scanning data to a remote device (e.g., an email server or a fax machine).

2. Description of the Related Art

There are many applications that need optical scanners to convert paper-based objects, such as texts and graphics, to an electronic format that can be subsequently analyzed, distributed and archived. One of the most popular optical scanners is flatbed scanners that convert scanning objects, including pictures and papers, to images that can be used, for example, for designing World Wide Web pages and optical character recognition. Another popular optical scanner is what is called sheet-fed scanners that are small and unobtrusive enough to be carried around, hence referred to as mobile scanners, to provide a handy scanning means.

A mobile scanner comes handy and is often used to convert actual printed or written materials into electronic format. For example, a journalist goes far away from a news bureau to collect information about an important event there. It is considerably useful such a portable or mobile scanner can be used to scan documents on site into a computer that then forwards the electronic versions to the news bureau for immediate news reporting or archival.

The current mobile scanners in the market are standalone devices whereas they generally operate with a computer via an interface (e.g., USB). A mobile scanner draws power from the computer to scan an object and transports the scanning image data to the computer. Although a portable computer is getting smaller, it is indeed somehow a burden to carry both a scanner and a computer.

Accordingly, there is a need for a scanner that is not only standalone but also operable without a computer.

### SUMMARY OF THE INVENTION

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

The present invention is generally related to a mobile scanner with functions to wirelessly transport scanning data to a computing device (e.g., a fax machine or an email server). Unlike a USB-based mobile scanner, the scanner contemplated in the present invention operates without being connected to a computing device. With a wireless module, the scanning data can be transported via a standard wireless protocol (e.g., WiFi, WiMAX, or Bluetooth), or a standard cellular standard (e.g., GSM or CDMA).

According to one aspect of the present invention, such a scanner may be used in any condition without having to connect to a computer. In addition, the scanner includes a demoutable base portion to allow scanning of a double-sided document.

The present invention may be implemented as an apparatus or a part of system. According to one embodiment, the present invention is a mobile scanner that comprises: an image sensing module; a motion mechanism to cause a scanning object to pass through the image sensing module to generate scanning data; and a wireless module to transport the scanning data out of the mobile scanner to another device.

According to another embodiment, the present invention is a mobile scanner that comprises: an image a portable housing, and an image sensing module mounted in the housing and comprising:
a one-dimensional image sensor array;
a lens mounted in front of the image sensor array; and an illumination source comprising three colored lights that are turned on independently and successively by an illumination control signal;
a motion mechanism working in synchronization with the image sensing module, the motion mechanism causing a scanning document illuminated by the illumination source to pass through the lens so that the scanning document can be imaged by the image sensor array to generate an image thereof; and
a wireless module to transport scanning data representing the image to another computer device.

There are many objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 shows a mobile scanner operating with a computer through a pair of interfaces connected with a communication cable;

FIG. 2 shows a systemic diagram of a prior art scanner that converts a paper-based scanning object to a corresponding digital image;

FIG. 3A shows an exemplar wireless module including a RF transceiver, a baseband process and processing (encoding/decoding) unit;

FIG. 3B shows one exemplary design of a scanner that includes a compartment with a cover;

FIG. 3C shows a functional block diagram of a wireless module according to one embodiment of the present invention;

FIG. 4 shows a cross-section view of a mobile scanner according to embodiment of the present invention;

FIG. 5 shows an internal block diagram of an interface engine implemented in a PC Card that may be used in present invention to couple the scanner to a computing device.

### DETAILED DESCRIPTION OF THE PREFERRED EMBODIMENTS

The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

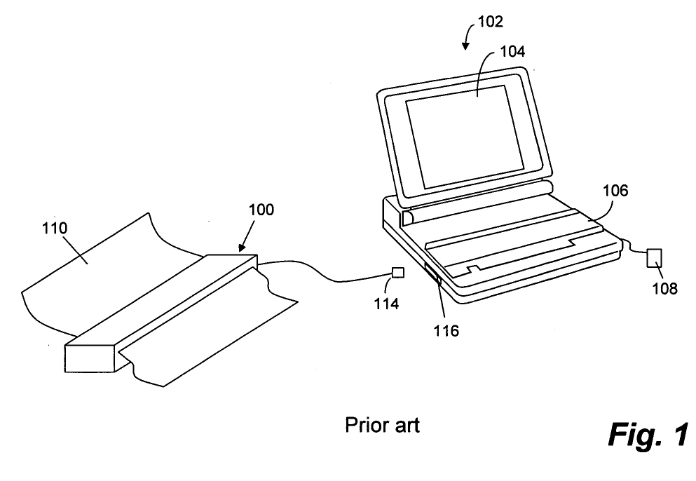

Referring now to the drawings, in which like numerals refer to like parts throughout the several views. FIG. 1 shows a mobile scanner 100 operating with a computer 102 through a pair of interfaces connected with a communication cable 112. In operation, not only does the mobile scanner 100 receive a power supply from the computer 102, typically 5V, but also becomes integrated into the computer 102, receiving various control signals therefrom.

In operation, the scanner 100 scans, line by line, a scanning object 110, such as a piece of paper with text and graphics on it. The scanning result, which is typically a digital representation of the scanning object 110, is transferred to the computer 102 through the communication cable 112 (i.e., the interfaces or USB 114 and 116). The digital representation may be converted to a standard image format, such as TIFF, JPEG and PDF, that may be manipulated for desired visual effects by another application program, such as PhotoShop from Adobe Systems, Inc. The digital representation or manipulated digital image can be displayed on a display monitor 104.

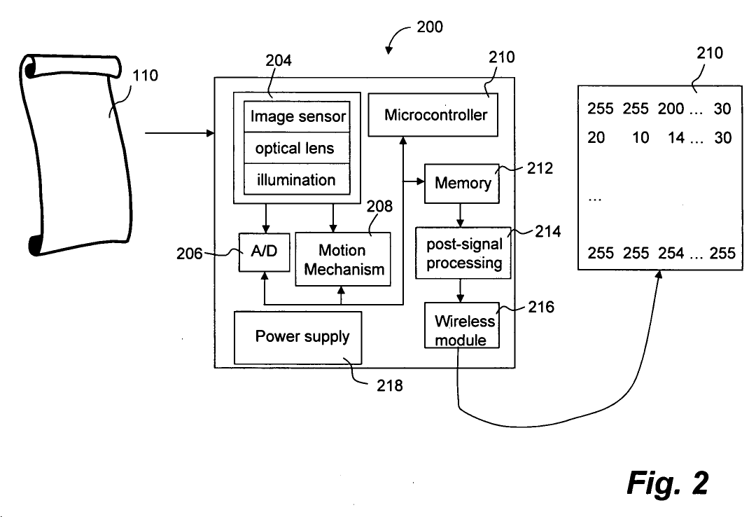

FIG. 2 shows a systemic diagram of a scanner 200 according to one embodiment of the present invention. One of the important features of the scanner 200 is that it operates on its own without the need to work with a computer. The scanner 200 converts a paper-based scanning object 110 to a corresponding digital image 202 that is received in an email server or a fax machine. The scanner 200 comprises an image sensing module 204, an analog-to-digital circuit 206, a motion mechanism 208, a microcontroller 210, memory 212, a post-processing module 214 and a wireless module 216.

The image sensing module 204 includes an array of photo sensor to convert a light signal to an electronic signal that is then digitized by the analog-to-digital circuit 206. The motion mechanism 208 controlled by the microcontroller 210 works in synchronization with the post-processing module or image sensing module 214. In operation, the image sensing module 204 images the scanning object 110 while the scanning object 110 is passing through the image sensing module 204 at a steady or controlled speed.

After the signals from image sensing module 204 are digitized by the analog-to-digital circuitry 206 to produce digital signals (raw data) representing the scanning object 110, the post-signal processing circuit 214 is designed to perform digital signals enhancement and often presents the digital signals in a standard image format, such as TIFF or PDF. The wireless module 216 prepares the images for real-time transmissions through a standard wireless protocol (e.g., WiFi, WiMAX, or Bluetooth), or a standard cellular standard (e.g., GSM or CDMA). In addition, the power supply 218 (e.g., battery or an external supply) is provided to energize all the parts in the scanner 200 to operate.

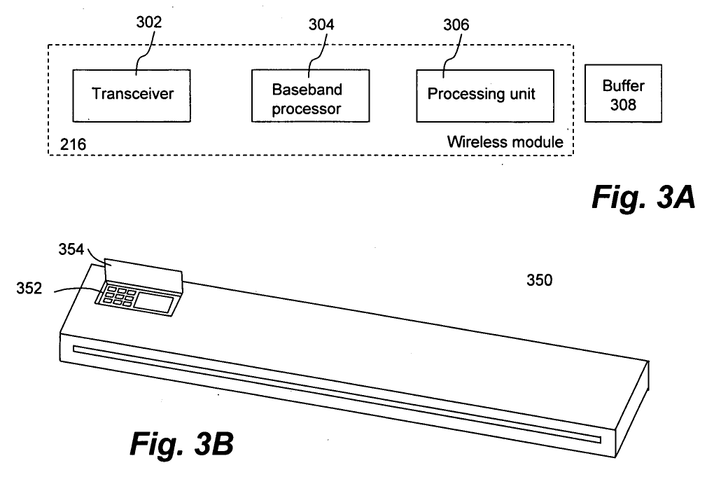

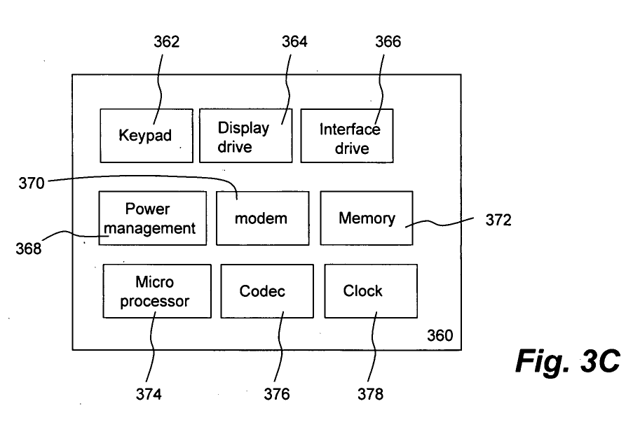

According to one embodiment as shown in FIG. 3A, the wireless module 216 includes a RF transceiver 302, a baseband processor 304 and a processing unit 306. In operation, the digital signal from the post-signal processing circuit 214 is coupled via a buffer 308 to the processing unit 306 for processing (e.g., encoding). The encoded data is then sent to the baseband processor 304 to be standardized according to a wireless protocol or standard before being sent to the RF transceiver 302 for transmission. Not shown in FIG. 3A is a microprocessor that may be provided or the microcontroller 210 is shared to synchronize the operations of the RF transceiver 302, the baseband processor 304, the processing unit 306 and other parts (not shown).

In one embodiment, the wireless module 216 is simply a cellular phone that is assigned a phone number. After a document is scanned, the image data thereof is first processed in the post-signal processing circuit 214 to encode the image data per the fax standard. The encoded data is then buffered in the buffer 308. A user dials the phone number, the image data is transmitted to a designated fax machine via a cellular network.

In another embodiment, the wireless module 216 is designed in accordance with the GSM network. Accordingly, a mobile scanner contemplated in the present invention provides a slot to accommodate a SIM card that is normally used in a regular GSM cellular phone. One of the advantages of providing a slot to accommodate a SIM card is that the scanner itself does not have to be provisioned to have a phone number. Any provisioned SIM card may be used to enable the scanner to transmit scanned data to a fax machine.

According to still another embodiment, the wireless module 216 is designed in accordance with a wireless standard. Thus the wireless module 216 is simply a modem facilitating data communication between the scanner and a computing device (e.g., an email server). In operation, the scanned data is transmitted to the computing device via a wireless network. Alternatively, after a user provides an email address, the scanned data is processed and transmitted to an email server as an attachment to an email destined to the email address.

FIG. 3B shows one exemplary design of a scanner 350 that includes a compartment 352 with a cover 354. The compartment 352 includes a set of keys and a display screen. The keys allow a user to enter a number for a fax machine or an email address. The display screen shows what has been entered. According to another embodiment, the compartment 352 may also include a slot to accommodate a SIM card to allow a user to dial out or transmit the scanning data to a fax machine or a computing device.

FIG. 3C shows a functional block diagram of a wireless module 360 according to one embodiment of the present invention. The wireless module includes a key pad circuit 361, a display drive 364, an interface drive 366, a power management 368, a modem 370, a memory 372, a micro-processor 374, a codec 376, and a clock 378. The key pad circuit 361 drives a set of keys allowing a user to type a phone number or an email address, or other connectivity data to facilitate the scanning data to be transported to another device. The display drive 364 drives a display screen (e.g., a LCD or even a touch screen) to display necessary information to the user.

The interface drive 366 is provided to interface one or more flash memory card such as MMC, USB or SD card. The interface drive 366 provides a mechanism to update the wireless module 360 and other functions therein. The power management 368 is designed to regulate or manage a power supply (e.g., battery or external power supply). In one embodiment, the power management 368 is designed to manage the power consumption to ensure that the battery lasts as long as possible by turning off parts that are not participating an operation at a time. For example, when a document is being scanned, the RF transceiver (e.g., the modem 370) is turned off as there is no need to transmit the data at the moment. The RF transceiver is turned on when the scanning of the document is done.

As the name suggests, the modem 370 provides an interface between the scanner and a wireless infrastructure. Depending on the wireless infrastructure, the modem 370 may be implemented in accordance with a wireless protocol and cellular standard. The memory 372 may be RAM or ROM storing necessary code to facilitate a micro-processor 374 to execute or synchronize the necessary parts to achieve a desired task or coordinate with other parts. The codec 376 is a pre-processing or post-processing circuit to a baseband processor (e.g., implemented in the microprocessor 374). When the scanning data is received, the data is encoded according to a protocol or standard. Likewise, command or handshaking data is received and processed in the codec 376 before being coupled to the micro-processor 374. The clock 378 is provided to synchronize all parts to work as desired.

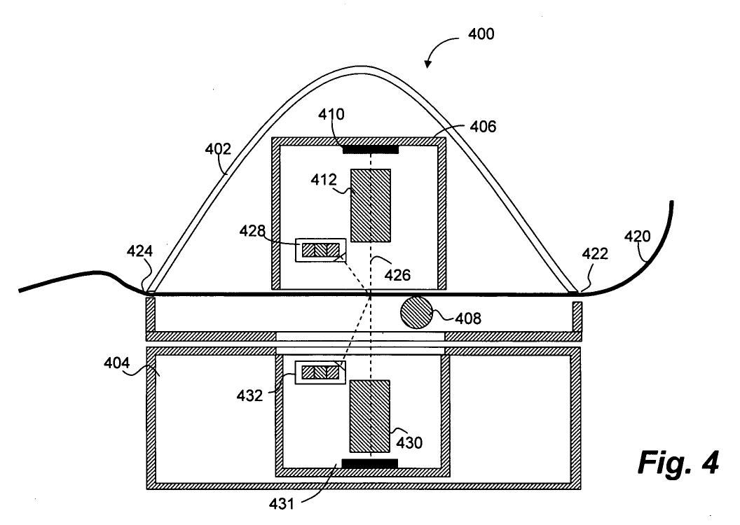

FIG. 4 shows a cross-section view of a mobile scanner 400 according to one embodiment of the present invention. The scanner 400, comprises two portions, a main portion 402 and a base portion 404, both are preferably made of an identical material. In one embodiment, the main portion 402 and the base portion 404 are demountable so that a user may not have to carry the base portion 404 if there is no need. The main case 402 houses an image sensing module 406 and a motion mechanism of which only a rubber surfaced rod 408 is shown. A scanning object 420 is received from a receiving opening 422, then moved by the moving rod 408 to pass an optical path 426 and exited from an exiting opening 424. When the scanning object 420 passes the optical path 426, the scanning object 420 is illuminated by a front illumination source 428, the reflected light from the scanning object 420 is collected by the lens 412 and focused upon the image sensor 410. It is noticed that the illumination source 428 is referred to as a front illumination source because it provides front illumination to a scanning object.

Besides a lens 430 and an image sensor 431, the base portion 404 comprises a second illumination source 432 which provides back illumination to the back side of the scanning object 420 and can be removably mounted to the main portion 402 when there is a need to scan a double-sided scanning object.

It should be pointed out that base portion 404 is one of the distinctive features of the present invention. With the base portion 404 mounted to the main portion 402, the mobile scanner 400 is capable of scanning a double-sided document. Typically, a user uses the main portion 402 for scanning paper-sheet materials in which case the illumination source 428 provides front illumination to the materials passing through the optical path 426. When the user decides to scan double-sided materials, the base module 404 can be mounted onto the main portion 402, in which case the illumination source 432 is on to provide back illumination to the other side of the double-sided materials. Those skilled in the art understand that necessary connectors can be provided to ensure that the electronic parts in the main and base portions 402 and 404 are properly coupled when the base portion 404 is mounted to the main portions 402.

Accordingly to another embodiment of the present invention, a photodetector (not shown) is used to detect if the scanning object 420 is present. A control circuit, not shown in the figure and understood to those skilled in the art, can automatically turn on the motion mechanism and other parts in the scanner 400.

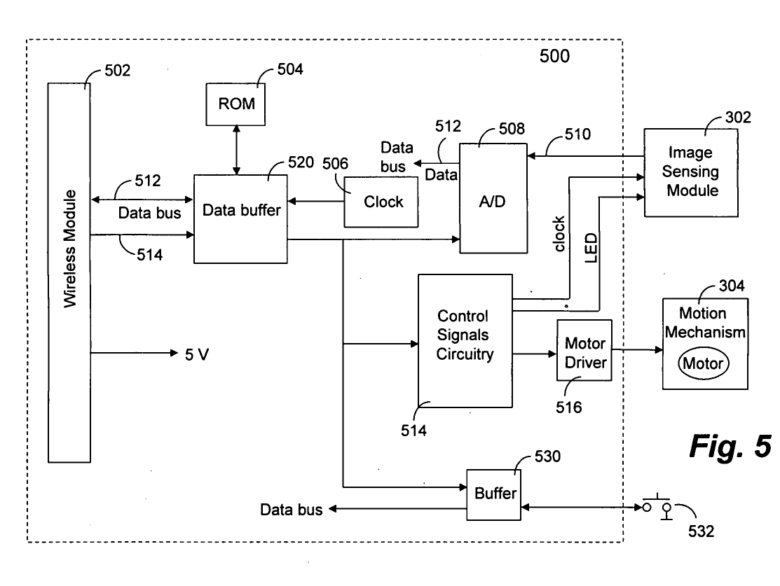

Referring now to FIG. 5, there is shown an internal block diagram 500 that may be used in the scanner 350 of FIG. 4. The wireless module 502 is an interface to transmit the scanning date to an external machine. The data buffer 520 provides a storage space to buffer the scanning data, for example, to convert the data into a file in PFD format as an attachment to an email or to encode the data according to a wireless standard. The Read Only Memory (ROM) 504 provides information how to convert or encode the data according to a standard. The clock 506, typically an oscillator circuit, provides a central clocking signal to all the parts in the scanner 500 to work in synchronization.

According to one embodiment, the image sensing module 302 outputs analog signals generated from the charge signals in the photodetectors of the image sensor when the image sensor is impinged with incident light (reflected or transmitted light) from a scanning object. The analog signals are received by an analog-to-digital (A/D) converter 508 through an analog signal line 510 and the resultant digitized (digital) signals are buffered in the data buffer 520. The illumination source in the image sensing module 302 is controlled and synchronized by control signals from the control signals circuitry 514 that operates under the clock 506. Typically, the illumination source comprises three primary colored lights, such as red, green and blue. To reproduce a color image, three primary color intensity images must be obtained. In other words, A/D converter 508 receives three analog signals respectively for each of the colored lights and produces respectively three digital signals.

The control signals from the control signals circuitry 514 ensures that only one of the three lights is “ON” at one time for a specific period and each of the lights is successively turned on. Similarly, to ensure that motion mechanism 304 to operate in synchronization with image sensing module 302, the motor drive 516 receives proper control signals from the control signals circuitry 514.

Each of the scanner control signals is used to synchronize the operation of a particular part. For example, three illumination control signals are generated to control the operation of the illumination source comprising the three colored lights. The timing in the illumination control signals is so designed that only one of the lights is turned on for a specific period at one time and the three lights are successively turned on. Similarly sensor control signals and motor control signals are generated with respect to the illumination control signals so that the image sensing module and the motion mechanism can work harmoniously to produce images of scanning objects.

Optionally, there is one protection control signal from the control signals circuitry 514 to the motor driver 516. The protection control signal is used to protect a motor in the motion mechanism 304. For example, in the middle of scanning a document, one of the parts malfunctions or the jam, the protection control signal can immediately cause the motor drive 516 to stop the operation of the motor.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

We claim:

1. A mobile scanner comprising;
an image sensing module;
a motion mechanism to cause a scanning object to pass through the image sensing module to generate scanning data; and
a wireless module to transport the scanning data out of the mobile scanner to another device.

2. The mobile scanner as recited in claim 1, wherein the wireless module includes a RF transceiver, a baseband processor and processing unit, and wherein the processing unit encodes the scanning data according to a wireless standard to produce encoded data to be coupled to the baseband processor for processing before being transmitted by the RF transceiver to the another device.

3. The mobile scanner as recited in claim 2, wherein the wireless standard is one of WiFi, WiMAX and Bluetooth.

4. The mobile scanner as recited in claim 1, wherein the wireless module includes functions of a cellular phone so that a user dials a number to cause the scanner to be connected to a fax machine.

5. The mobile scanner as recited in claim 4, wherein the wireless module further includes a slot to accommodate a SIM card.

6. The mobile scanner as recited in claim 1, wherein the wireless module includes functions of a cellular phone so that a user dials a number to cause the scanner to be connected to a fax machine.

7. The mobile scanner as recited in claim 1 including a set of keys and a display screen, wherein the keys allow a user to enter a number to a fax machine or an email address, and the screen displays what the user enters.

8. The mobile scanner as recited in claim 7, further including functions to convert the scanning data to a file as an attachment to an email.

9. The mobile scanner as recited in claim 1 comprising:
a main portion having an elongated receiving opening and an elongated exiting opening, wherein the scanning document is caused by the motion mechanism to pass from the receiving opening and exit from the exiting opening; and
a base portion demountably mounted to the main portion.

10. The mobile scanner as recited in claim 9, wherein the main portion includes the image sensing module, the motion mechanism and the wireless module, the main portion produces the scanning data representing a front side of the scanning object.

11. The mobile scanner as recited in claim 10, wherein the base portion includes another image sensing module to produce the scanning data representing a back side of the scanning object.

12. The mobile scanner as recited in claim 1, wherein the mobile scanner operates on batteries or an external power supply.

13. A mobile scanner comprising:
a portable housing;
an image sensing module mounted in the housing and comprising:
a one-dimensional image sensor array;
a lens mounted in front of the image sensor array; and an illumination source comprising three colored lights that are turned on independently and successively by an illumination control signal;
a motion mechanism working in synchronization with the image sensing module, the motion mechanism causing a scanning document illuminated by the illumination source to pass through the lens so that the scanning document can be imaged by the image sensor array to generate an image thereof; and
a wireless module to transport scanning data representing the image to another computer device.

14. The mobile scanner as recited in claim 13, wherein the wireless module includes a RF transceiver, a baseband processor and processing unit, and wherein the processing unit encodes the scanning data according to a wireless standard to produce encoded data to be coupled to the baseband processor for processing before being transmitted by the RF transceiver to the computer device.

15. The mobile scanner as recited in claim 14, wherein the wireless standard is one of WiFi, WiMAX and Bluetooth.

16. The mobile scanner as recited in claim 13, wherein the wireless module includes functions of a cellular phone so that a user dials a number to cause the scanner to be connected to a fax machine.

17. The mobile scanner as recited in claim 16, wherein the wireless module further includes a slot to accommodate a SIM card.

18. The mobile scanner as recited in claim 13, wherein the wireless module includes functions of a cellular phone so that a user dials a number to cause the scanner to be connected to a fax machine.

19. The mobile scanner as recited in claim 13 including a set of keys and a display screen, wherein the keys allow a user to enter a number to a fax machine or an email address, and the screen displays what the user enters.
